(19) United States
(12) Patent Application Publication
(10) Pub. No.: US 2018/0356032 A1
(43) Pub. Date: Dec. 13, 2018

(54) Mount

(71) Applicant: Ramona Bernhardt CRIDER, Plano, TX (US)

(72) Inventor: Ramona Bernhardt CRIDER, Plano, TX (US)

(21) Appl. No.: 16/002,407

(22) Filed: Jun. 7, 2018

Related U.S. Application Data
(60) Provisional application No. 62/517,608, filed on Jun. 9, 2017.

(51) Int. Cl. F16M 13/02; F16B 7/10; F16B 2/00; F16B 2/10

(52) U.S. Cl. CPC F16M 13/022; F16B 7/10; F21V 21/088; F16B 2/10; F16M 2200/06; F16B 2/005

(57) ABSTRACT

A method and apparatus for mounting an object relative to a support structure, for example, a table. In a first aspect, the mount comprises a clamp, an elongated body, and a holder, for example, a clip. The elongated body comprises a first end portion coupled to the clamp and a second end portion. The holder is coupled to the second end portion of the elongated body. In a second aspect, a method of using the mount comprises several steps. A first step comprises providing the clamp in an open configuration. A second step comprises positioning the clamp around a support structure. A third step comprises adjusting the clamp to a closed position to removably fix the clamp to the support structure. A fourth step comprises coupling the object to the holder.

### CROSS-REFERENCE TO RELATED APPLICATIONS

This application is a nonprovisional application of, and claims priority to, U.S. Provisional Patent Application No. 62/517,608, filed on Jun. 9, 2017, which is incorporated herein in its entirety as an example.

### BACKGROUND

### Technical Field

The present invention relates to mounts for positioning an object, for example, an adjustable-length mount that is removably coupled to a support structure and that can be used to position an object relative to the support structure.

### Background

Existing devices for mounting objects at a specified or elevated height generally involve attaching screws or nails to walls and/or existing support structures, or in the alternative requires large pole stands. These existing devices or methods are likely to damage walls and/or the existing support structures, or tend to be undesirably heavy, for example, to keep the pole stands and the object mounted on the pole stands stable. Also, use and placement of existing devices and methods depend on the structure of the event area for which there will be mounted objects.

There are more disadvantages with currently existing devices and methods for mounting objects at a specified height. There can be problems with fire code violations depending on the height of the mounted object. It can be difficult for individuals below a certain height to position an object at a higher specified height. It can also be difficult for people in general, and especially individuals with relatively less strength, to install or move heavy poles, or to make adjustments to a mount that require exerting undesirably high amounts of force or energy. In an effort to mitigate some of these issues, existing devices can require ladders and other tools to facilitate mounting objects. Existing devices (e.g., pole stands) can also be too expensive. Furthermore, in some situations, for example, for events requiring a specified amount of illumination, mounted candles can be ineffective because of the setting, space constraints, safety/fire considerations, inability to provide enough candles and/or inability to position the candles to provide enough light in specified locations, for example, at a table where people are eating.

As can be seen, existing devices leave much to be desired. Accordingly, Applicant has developed an improved and/or alternative device that, in some embodiments, is capable of replacing and/or improving upon existing wall mounts and/or pole stands. For example, in some embodiments, Applicant's device provides an improved and/or alternative device for positioning an object in a desired location (e.g., specified height; specified proximity to an area to be illuminated; specified proximity to an area to be provided with sound, a media device, a touch screen, a speaker, a message, a decoration, or some combination thereof). Additionally, in some embodiments, Applicant's device is relatively safe, effective, easy-to-use, light-weight, relatively less expensive, affordable, requires relatively little strength to position, or provides some combination of these advantages.

### SUMMARY OF THE INVENTION

In a first aspect, the invention provides a method of using a mount comprising a clamp coupled to an elongated body, which elongated body is coupled to a holder for an object. The method comprises several steps. A first step comprises providing the clamp in an open configuration. A second step comprises positioning the clamp around a support structure. A third step comprises adjusting the clamp to a closed position to removably fix the clamp to the support structure. A fourth step comprises coupling the object to the holder.

In a second aspect, the invention provides an apparatus comprising a mount. The mount comprises a clamp, an elongated body, and a holder. The elongated body comprises a first end portion coupled to the clamp and a second end portion. The holder is coupled to the second end portion of the elongated body.

In a third aspect, the invention provides an apparatus comprising a mount. The mount comprises a clamp, an elongated body, and a holder. The elongated body comprises a first portion coupled to the clamp and a second portion. The holder is coupled to the second portion of the elongated body.

In a fourth aspect, the invention provides an apparatus comprising a mount. The mount comprises a support-structure coupling, an elongated body, and a holder. The elongated body comprises a first portion coupled to the support-structure coupling and a second portion. The holder is coupled to the second portion of the elongated body.

In a fifth aspect, the invention provides a mount. The mount comprises a clamp, an elongated body, and a holder. The elongated body comprises a first portion coupled to the clamp and a second portion. The holder is coupled to the second portion of the elongated body.

In a sixth aspect, the invention provides a mount. The mount comprises a support-structure coupling, an elongated body, and a holder. The elongated body comprises a first portion coupled to the support-structure coupling and a second portion. The holder is coupled to the second portion of the elongated body.

In a seventh aspect, the invention provides a method of using a mount or an apparatus comprising a mount. The mount comprises a clamp coupled to an elongated body, which elongated body is coupled to a holder for an object. The method comprises several steps. A first step comprises providing the clamp in an open configuration. A second step comprises positioning the clamp around a support structure. A third step comprises adjusting the clamp to a closed position. A fourth step comprises coupling the object to the holder.

In an eighth aspect, the invention provides a method of using a mount or an apparatus comprising a mount. The mount comprises a support-structure coupling that is coupled to an elongated body, which elongated body is coupled to a holder for an object. The method comprises several steps. A first step comprises providing the support-structure coupling in an open configuration. A second step comprises positioning the support-structure coupling around a support structure. A third step comprises adjusting the support-structure coupling to a closed position. A fourth step comprises coupling the object to the holder.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of an apparatus with a mount for mounting an object to a support structure, in which the object is coupled to a holder and the mount is coupled to the support structure via a clamp, as illustrated, an opening of the clamp oriented substantially perpendicular to an elongated body of the apparatus.

FIG. 2 illustrates an exemplary embodiment of the present invention, where the clamp of the present invention comprises a vertical orientation for coupling to a support structure or where the clamp comprises an opening oriented substantially parallel to an elongated body of the apparatus.

FIG. 3 illustrates a first embodiment of a holder coupled to the mount, in which the holder has at least one aperture (e.g., one aperture or a plurality of apertures) on a surface of the holder, for example to enable an object (e.g., string, rope, twine, cord, material, fabric, string of lights, etc., or a combination thereof) to be positioned in the at least one aperture, coupled to the at least one aperture and/or strung through a plurality of apertures that make up the at least one aperture.

FIG. 4 illustrates a second embodiment of holder coupled to a mount, in which the holder has two arms with clips positioned on the arms, for example, at a distal end of each arm.

FIG. 5 illustrates an embodiment comprising an inner clamp material on a portion of a clamp (e.g., inner clamp inner surface) that can be used, for example, to prevent damage to a support structure to which the clamp is coupled.

FIG. 6 illustrates an embodiment of a method for using a mount or apparatus described herein to mount an object.

FIG. 7 illustrates an embodiment comprising a clamp inner surface, which can include a support-structure contacting portion of a spindle assembly, in which the clamp inner surface can be provided, configured, positioned and/or oriented to prevent damage to a support structure to which the clamp is attached.

FIG. 8 illustrates an approach to measuring the dimensions of an article described herein, for example, by circumscribing the object with a rectangular prism.

FIG. 9 illustrates two potential different approaches to measuring the dimensions of an article described herein, with one approach establishing a longitudinal dimension based on the longest distance between two points on a surface of the article and with another approach establishing a longitudinal dimension that is measured in the vertical direction, and thus based on the longest vertical distance between two points on the surface of the article, and which thus depends on the orientation of the article and provides an indication of how high the article reaches.

FIG. 10 illustrates a maximum clamp gap, which can vary based on the structural geometry of a clamp.

FIG. 11 illustrates an elongated body comprising multiple rods, in which at least one inner rod is configured to telescope out of at least one outer rod, in which the at least one inner rod comprises a push button insert, and in which the at least one outer rod comprises a plurality of apertures configured to receive the push button insert, thereby providing the elongated body with adjustability between at least two different fixed lengths.

FIG. 12 illustrates an elongated body comprising a plurality of threaded rods, in which a threaded surface of a first rod is engaged with a threaded surface of a second rod adjacent to and inside or outside the first rod, to provide a pair of mutually rotatable rods, thereby enabling extension or retraction of the elongated body.

FIG. 13 illustrates an exemplary embodiment of a holder in the form of a clip that is configured to be removably coupled to the mount.

FIG. 14 illustrates a component of the present invention that is rigid, for example, constructed of a material that that bends by no more than 0 degrees to 15 degrees under specified forces, forces expected to be encountered during installation, forces expected to be encountered during adjustment, forces expected to be encountered during deconstruction, or a combination thereof.

### DETAILED DESCRIPTION

Referring to the drawings, embodiments of the present invention will be described below.

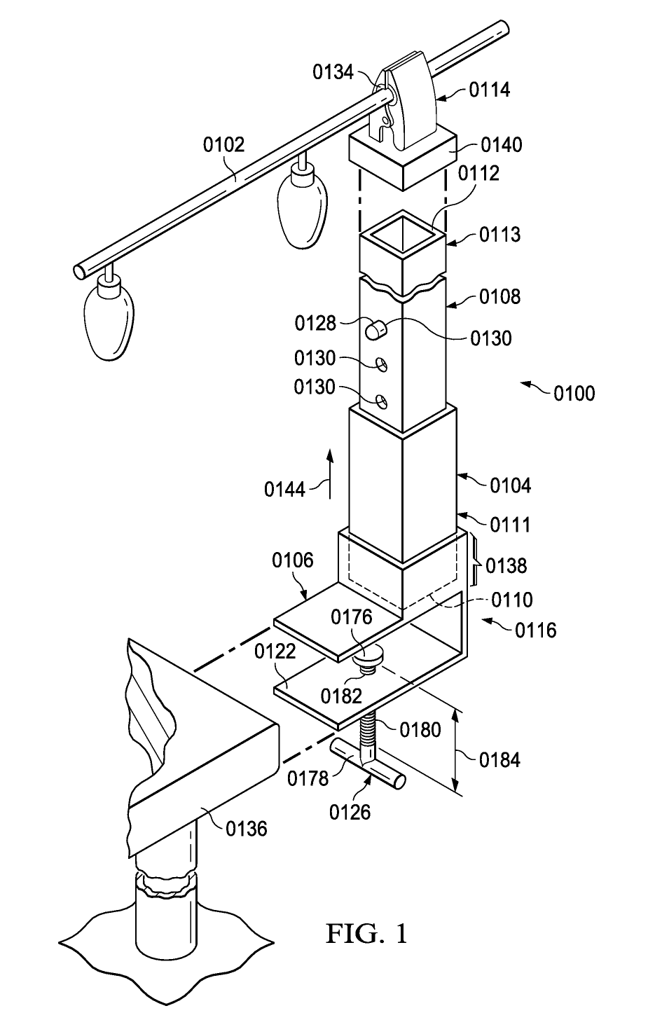

FIG. 1 shows a perspective view of an apparatus 0100 for mounting an object 0102 to a support structure 0136. The apparatus 0100 is portable and may be attached to any portion of a support structure 0136 for mounting an object 0102 at an elevated or prescribed height above the support structure 0136. The apparatus comprises a mount 0104, and the mount comprises a clamp 0106, an elongated body 0108, and a holder 0114. The elongated body 0108 has a first end portion 0111 (e.g., first end 0110) and a second end portion 0113 (e.g., second end 0112), with the first end portion 0111 coupled to (e.g., as used herein, coupled to can be secured or fixed in a specified proximity to, fixed to, removably fixed to, permanently fixed to, attached to, clamped to, screwed to, nailed to, bolted to, snapped to, clipped to, adhered to, magnetically attracted to, integral with, of a single piece with, or a combination thereof) the clamp 0106 and the second end portion 0113 coupled to the holder 0114. The apparatus 0100 is used with a support structure 0136, and the support structure 0136 can be a chair, a table, or any object with a ledge to which the apparatus 0100 can be coupled (e.g., attached). The support structure can also comprise a protrusion that fits inside the clamp 0106.

In some embodiments, the large size or weight of the support structure can make it undesirable to move the support structure. Accordingly having a detachable and/or mobile mount, as opposed to a mount that is permanently fixed to the support structure, can be advantageous. Additionally, the support structure can be configured to support the weight and geometry of the mount without becoming structurally unstable, tipping over, breaking, etc. or a combination thereof. For example, the support structure can weigh significantly more than the mount, the support structure can be coupled (e.g., bolted) to another structure (e.g., a concrete foundation), the support structure can have a mass and center of mass positioned relative to the mass and center of mass of the mount to avoid structural instability, or a combination thereof.

The clamp 0106 of the mount 0104 of the apparatus 0100 can be made of metal, plastic, composite, or any suitably rigid material. The clamp 0106 can be made of metal or plastic, for example, for the structural strength, durability, a relatively high tensile and/or compressive strength to weight, and/or relatively low density of these materials in some embodiments. The grade of the clamp 0106 material can vary depending on the weight of the object 0102 to be mounted using the apparatus 0100. The clamp 0106 can vary in dimension and shape, but will generally have a shape so as to facilitate the coupling (e.g., fixation, attachment) of the mount 0104 to the support structure 0136. In an exemplary embodiment, the clamp 0106 is a C-clamp, so that when the mount 0104 is coupled to the support structure 0136, the clamp 0106 adjusts to the width of the area of the support structure 0136 to which the clamp 0106 is coupled, and a c-clamp allows for such adjustment. The clamp can use a clamp spindle assemble 0126 for ease of use of the apparatus 0100 without use of tools. The use of a C-clamp for the clamp 0106 is because a C-clamp allows for adjustment to different thicknesses when attaching the apparatus 0100 to the support structure 0136. Other types of clamps may be used for the clamp to allow for adjustment to different thicknesses of different support structures. Additionally, the clamp 0106 can have a collar 0138 so that the clamp 0106 can be coupled to and removed from the elongated body 0108.

As mentioned previously, the elongated body 0108 of the mount 0104 is coupled to the clamp 0106 at the first end portion 0111 of the elongated body 0108. For example, a collar 0138 can be sized to fit snugly around or within (e.g., in frictional contact with) a first end portion 0111 of the elongated body 0108 of the mount 0104. The elongated body 0108, like the clamp, can be made of metal, plastic, composite, or any suitably rigid material, and can be made of metal or plastic, for example, for the structural strength, durability, a relatively high tensile and/or compressive strength to weight, and/or relatively low density of these materials in some embodiments. The grade of the elongated body 0108 material can vary depending on the weight of the object 0102 to be mounted using the apparatus 0100. The elongated body 0108 can vary in dimension and shape, but will generally have a rod-like shape. For example, the elongated body 0108 can have a round cross-section (e.g., oval shaped, circle shaped) or a rectangular prism shaped (e.g., square, rectangular) cross-section.

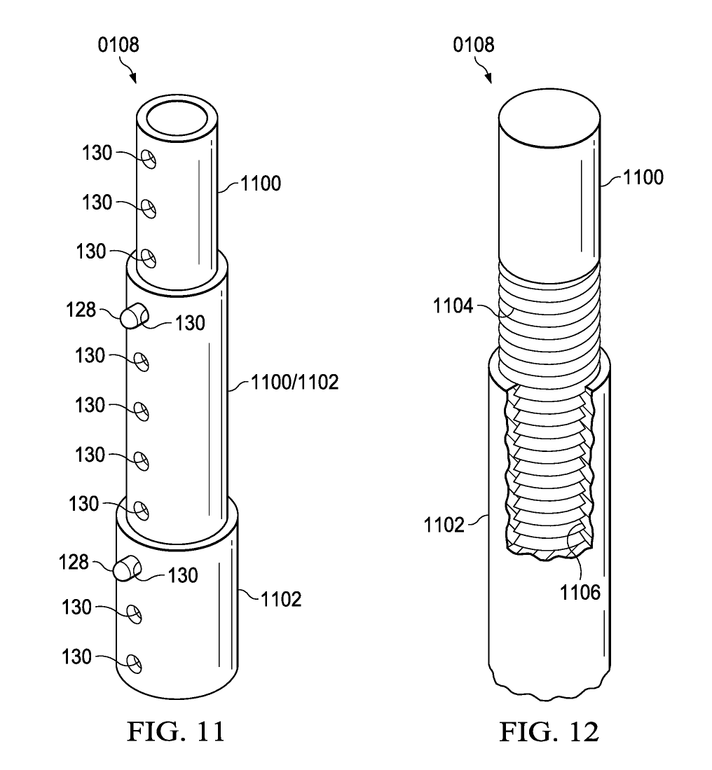

The elongated body 0108 can have telescoping functionality. In an exemplary embodiment, the elongated body can comprise at least one inner rod 1100 (e.g., of essentially any cross-sectional shape) inside at least one hollow outer rod 1102. When a user desires to adjust a dimension (e.g., length, etc.) of the mount 0104, the user can extend or retract the elongated body 0108 by moving the at least one inner rod further out of or into the hollowed-out rod or vice versa. In order to secure the telescoping elongated body 0108, a variety of mechanisms can be used. For example, with reference to FIG. 11, in some embodiments, the at least one inner rod 1100 and/or the at least one hollow outer rod 1102 can comprise a plurality of apertures 0130, and/or a push buttons insert 0128 that are configured to extend into at least one of the plurality of apertures 0130. In some embodiments, at least one inner rod 1100 and/or the at least one hollow outer rod 1102 can comprise a spring lock. In some embodiments, the at least one inner rod comprises threading 1104 that corresponds to threading 1106 on the at least one outer rod so that the rods can be twisted relative to each to extend or retract the elongated body 0108. With reference to FIG. 12, in some embodiments, each inner rod of the at least one inner rod 1100 comprises threading 1104 that corresponds to threading 1106 on an adjacent outer rod of the at least one outer rod 1102 so that each inner rod can be twisted (e.g., screwed) relative to each corresponding outer rod to extend or retract the elongated body 0108. It is also contemplated that a plurality of mechanisms for telescoping can be used on an inner rod, at least one inner rod, outer rod, at least one outer rod, or a combination thereof. Similarly, it is contemplated that a the telescoping portion of an elongated body can comprise at least one and/or no more than 2, 3, 4, 5, 6, 7, 8, 9, or 10 inner rods, outer rods, or a combination thereof.

Different types of telescoping rods allows for a greater variety of objects to be mounted. For example, the weight that each type of telescoping rod supports is different depending on the type; for example, the push button type telescoping rods can support a heavier than the threaded telescoping rods. For this advantage, the present invention allows for a greater variety of customized arrangements of the apparatus for use. Additionally, differently sized telescoping rods can be useful, for example, in the context of 3D printing or laser cutting an apparatus comprising a mount, or any of its components. For example, if a laser cutter, 3D printer, or other automated production technique is limited by a maximum product length, it can be useful for one or more components of the apparatus or mount (e.g., the rods used to provide a telescoping elongated body) to be shorter than the maximum product length.

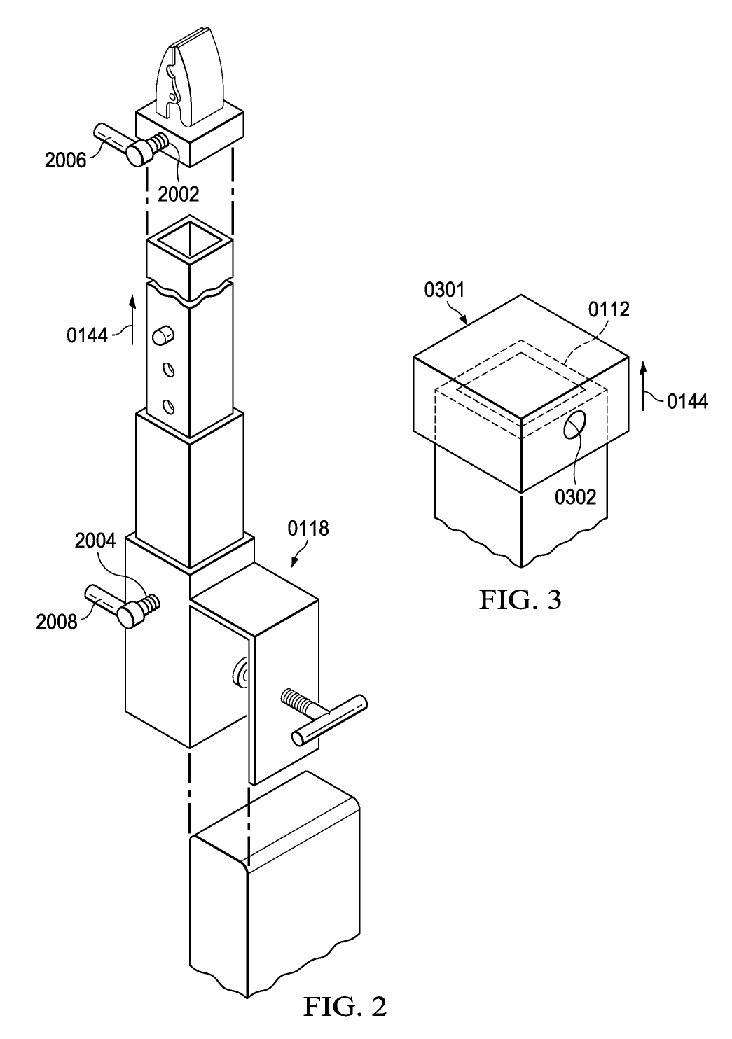

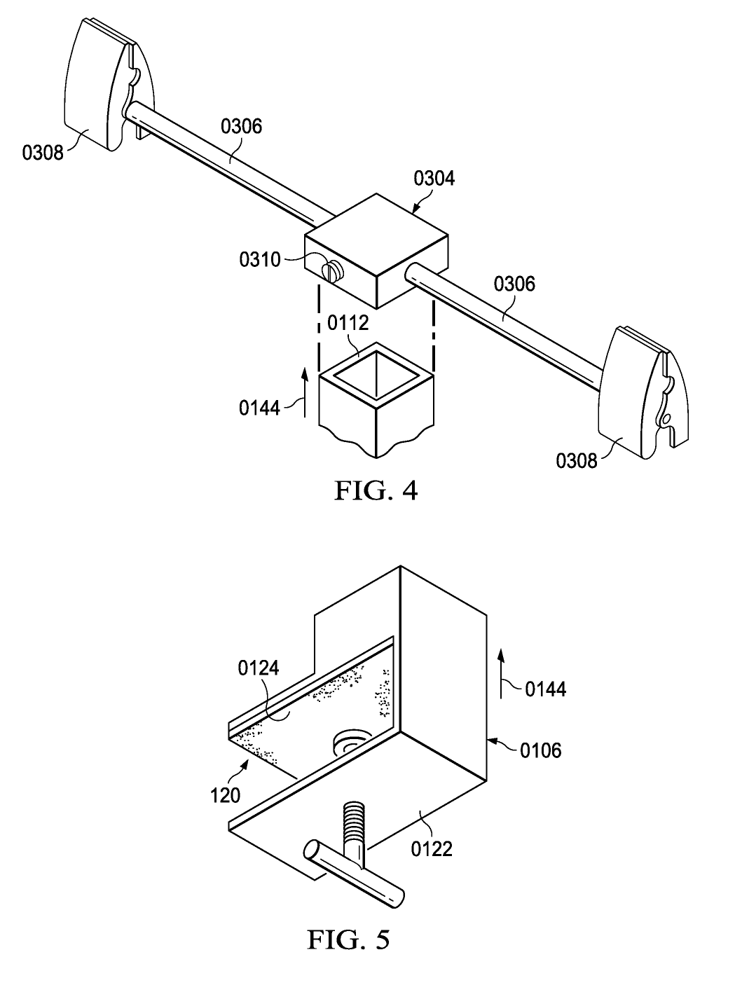

As previously mentioned, the holder 0114 is coupled to the second end portion 0113 of the elongated body 0110. The holder 0114, like the clamp 0106 and the elongated body 0108, can be made of metal, plastic, composite, or any suitably rigid material, and can be made of metal or plastic, for example, for the structural strength, durability, relatively high tensile and/or compressive strength to weight, and relatively low density of these materials in some embodiments. The grade of the holder 0114 material can vary depending on the weight of the object 0102 to be mounted using the apparatus 0100. The holder 0114 can vary in dimension and shape, and can comprise a clip, an aperture (e.g., a slot, a hole), or a plurality of arms with clips at the end of the arms. The exemplary embodiment in FIG. 1 illustrates the holder 0114 comprises a clip. The holder 0114 can comprise a collar 0140 to facilitate coupling the holder to and removing the holder from the elongated body 0108. For example, the collar 0140 can be sized to fit snugly around or within (e.g., in frictional contact with) a second end portion 0113 of the elongated body 0108 of the mount 0104. Additionally, for any component (e.g., holder, clamp, support-structure coupling, or combination thereof) of a mount comprising a collar 0138, 0140, the collar can comprise a cap at a portion (e.g., distal portion, distal end, top portion, top end, bottom portion, bottom end) of the collar, as illustrated with reference to FIG. 1, FIG. 2, FIG. 3 and FIG. 4, which depict a holder with a cap. FIG. 5 also depicts a clamp/support-structure coupling with a cap. For example, the cap can prevent the elongated body 0108 from sliding and/or extending past the cap. Nonetheless, the collar need not comprise a cap, for example, as an alternative, the collar can be an open collar (e.g., without a collar) and coupled or secured in position relative to the elongated body, for example, with a pin, button, screw, or other suitable coupling element (e.g., as described herein). Additionally, for example, when using a holder with an open collar, a plurality of holders (e.g., a holder comprising an open collar, a plurality of holders comprising an open collar, two or three holders comprising an open collar, a holder comprising a cap, or a combination thereof) can be coupled to the elongated body and provide additional functionality, arrangements, orientations, and flexibility in terms of coupling one or more objects to the plurality of holders or positioning one or more objects relative to the elongated body or a support structure).

The holder 0114 can have a liner 0134 along the inner surface of the holder. Because the holder directly contacts the object 0102 to be mounted, the direct contact between the holder 0114 and the object 0102 can cause wear and tear of the object 0102. Accordingly, a liner 0134 can be coupled to the inside of the holder 0114. For example, the liner can be a damage-avoidant material as described herein. In the present exemplary embodiment, the holder 0114 comprises a clip, and the liner in this present exemplary embodiment comprises a holder grip (e.g., clip grip) that is coupled to the holder (e.g., clip) and lines the inside of the holder and part of the outside of the holder. The liner 0134 can be coupled or attached to and cover any portion of the inside of the holder 0114 and can also cover any portion of the outside of the holder 0114.

Further, instead of a liner as shown in FIG. 1, the surface of the inside of the clip of the present exemplary embodiment can be scratch-avoidant (e.g., soft inner surface, inner surface having a scratch hardness less than the scratch hardness of a support structure 0136 in contact with or gripped by the inner surface, rubber inner surface, rubberized inner surface, silicone rubber inner surface, or a combination thereof). The surface of the inside of the clip or any type of holder can be frictional (e.g., having a friction-enhancing coating to increase the coefficient of static friction between the inner surface and a support structure 0136 in contact with or gripped by the inner surface; having a coefficient of static friction in conjunction with a support structure 0136 in contact with or gripped by the inner surface).

In some embodiments, the present invention is advantageous because it can be coupled to any type of support structure 0136 and any portion of the support structure 0136. Multiples of the present invention allow for customized arrangement of the mounted object 0102. For example, for outdoor events with long tables, multiples of the apparatus 0100 may be placed around the long tables, and objects like light fixture strings may be mounted on the apparatus in a variety of arrangements for maximum effect and/or aesthetics.

In other embodiments, any of the components of the present invention (e.g., the clamp 0106, the elongated body 0108, or the holder 0110) may be made of a material that bends. The advantage of this features is for the structural integrity of the component as the component assists in supporting the weight of the mounted object, and also for a greater variety of customized arrangements of the mounted object.

FIG. 2 illustrates an exemplary embodiment of the present invention, where the clamp comprises a vertical orientation. FIG. 1 illustrates the clamp 0106 in a horizontal orientation. In the horizontal orientation, the clamp 0106 can be coupled to an area of the support structure that is parallel to the ground. In the vertical orientation, the clamp 0106 can be coupled to an area of the support structure that is perpendicular to the ground. This vertical orientation can be used for support structure like chairs with thin armrests, so that the mount can be coupled to the armrests. The vertical orientation of the clamp 0106 can be used with any combination of components of the apparatus 0100.

The vertical orientation of the clamp is advantageous for when the area of the support structure to which the clamp couples is perpendicular to the ground, or at an angle to the ground. For example, the apparatus may be coupled to the arm of a patio furniture chair, and the patio furniture chair may not have a protrusion that would stably support the apparatus 0100 in the horizontal orientation.

FIG. 3 and FIG. 4 illustrate two types of holders that can be coupled to the second end portion 0113 of the elongated body 0108. FIG. 3 illustrates a holder 0301 comprising an aperture 0302 on the side of the holder 0114. The holder 0114 can also comprise more apertures along the perimeter and/or outer surface of the holder 0114. For example, the holder 0114 can comprise a second aperture on the side parallel to aperture 0302, so that the object 0102 can pass through aperture 0302 and through the second aperture. FIG. 4 illustrates another holder 0304 with two arms 0306 with clips 0308 at the ends of the arms 0306. The holder also comprises a coupling element 0310 (e.g., tensioning screw, button, etc., or a combination thereof) to couple the holder 0304 to the elongated body 0108. This type of holder 0304 allows for multiple objects 0102 to be mounted, or a single object 0102 to be mounted twice (e.g. a string of lights or light fixtures) for stability. The holder 0304 can be constructed of any suitably rigid material, like the holder of FIG. 1, and can be constructed from plastic or metal of a grade that supports the weight of the object 0102, and optionally, that provides durability, relatively high tensile strength and/or compressive strength to weight, and/or a relatively low density. The arms 0306 of the holder 0304 extend in a direction perpendicular to the sides of the holder 0304 to which the arms 0306 are coupled. The length and diameter of the arms 0306 can vary depending on the weight of the object 0102 to be mounted. The clips at the end of the arms 0305 can also vary in grade and material depending on the weight of the weight of the object 0102 to be mounted. The holder 0304 can comprise any number of arms 0306, and the exemplary embodiment shown in FIG. 3 illustrates the holder can comprise two arms 0306.

Different types of holders are advantageous for the present invention because different holder allow for greater variety of customized arrangements of mounted objects. For example, a two-armed holder with clips at the ends of the arms may support multiple mounted objects, and allows for more variations of arrangements of the multiple mounted objects. Additionally, in some embodiments, a holder is or plurality of holders are configured to avoid damaging electrical wires or other fragile chord- or cable-like object. For example, the holder (e.g., clip of a holder, hole or opening in a holder) can comprise an aperture having a cross-sectional size and shape that fits snuggly against the chord- or cable-like object, but avoids cutting into the chord- or cable-like object. Additionally, the holder can comprise a damage-avoidant material (e.g., a soft material, a smooth material, a dull or unsharp material, rubber, plastic, etc., or a combination thereof) configured to be in contact with the object while avoiding causing punctures, cuts, tears or other damage to the object. The damage-avoidant material can be coupled to an outer surface of the holder, inner surface of the holder, surface of the holder configured to contact the object, or combination thereof. Additionally, the entire holder can be made of the damage-avoidant material.

FIG. 5 and FIG. 7 illustrate the use of an inner clamp material 0124 (e.g., inner material, layer, lining, coating or combination thereof) of the clamp 0106. Because the apparatus 0100 can be used with a support structure, for example, a table, it could be possible for the apparatus 0100 to damage the support structure 0136, for example, scratching the surface of the support structure 0136. Accordingly, an inner clamp material 0124 can be coupled to the underside 0120 of the clamp 0106. FIG. 5 illustrates the inner clamp material 0124 that is coupled to or covers only the top of the underside 0120 of the clamp, and FIG. 7 illustrates the inner clamp material 0124 that is coupled to or covers the entire underside 0120 of the clamp. The inner clamp material 0124 can be coupled to or cover any portion of the underside 0120 of the clamp 0106 so as to prevent scratches to any support structure to which the apparatus 0100 is coupled (e.g., mounted).

Further, instead of an inner clamp material 0124 as shown in FIG. 5 and FIG. 7, the surface of the underside 0120 of the clamp 0106 can be scratch-avoidant (e.g., a soft inner surface, an inner surface having a scratch hardness less than the scratch hardness of the support structure 0136 in contact with or gripped by the inner surface, a rubber inner surface, a rubberized inner surface, a silicone rubber inner surface, or a combination thereof). The surface of the underside 0120 of the clamp 0106 can be frictional (e.g., having a friction-enhancing coating to increase the coefficient of static friction between the surface of the underside 0120 and a support structure 0136 in contact with or gripped by the surface of the underside 0120). The inner clamp material 0124 of the clamp 0106 is advantageous because it not only helps prevent damage to the support structure, but it also helps stabilize the apparatus 0100 because the inner clamp material 0124 may be rubberized to improve the grip of the apparatus 0100 to the support structure 0136.

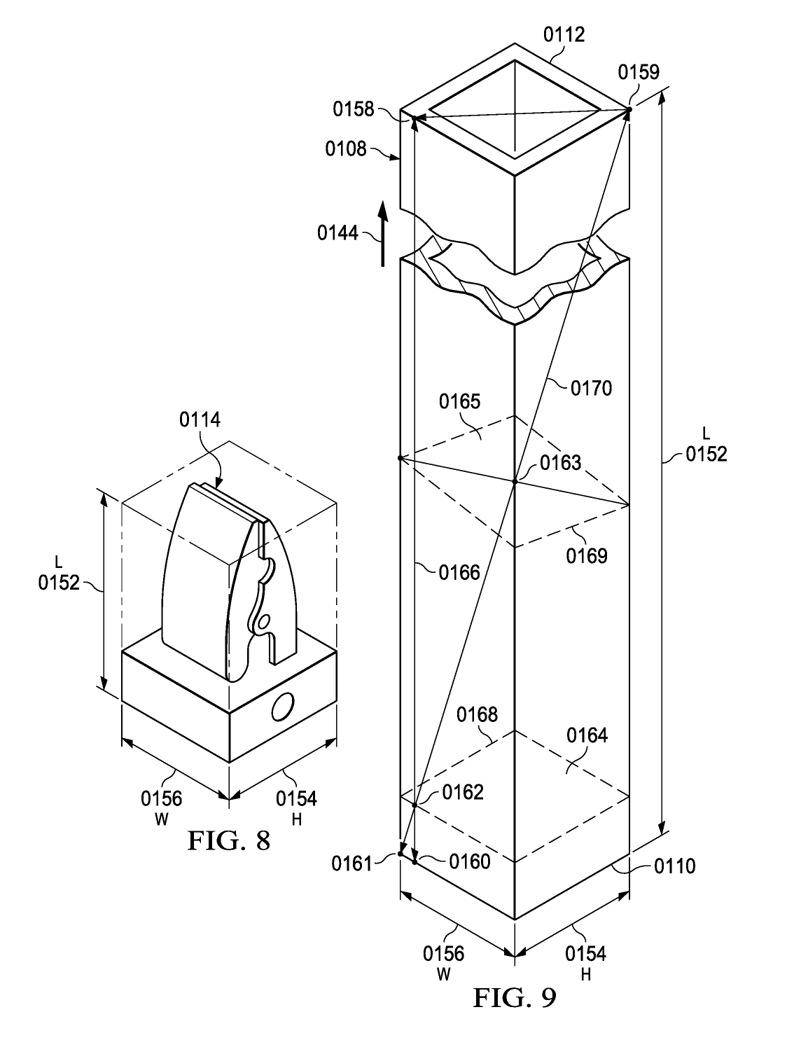

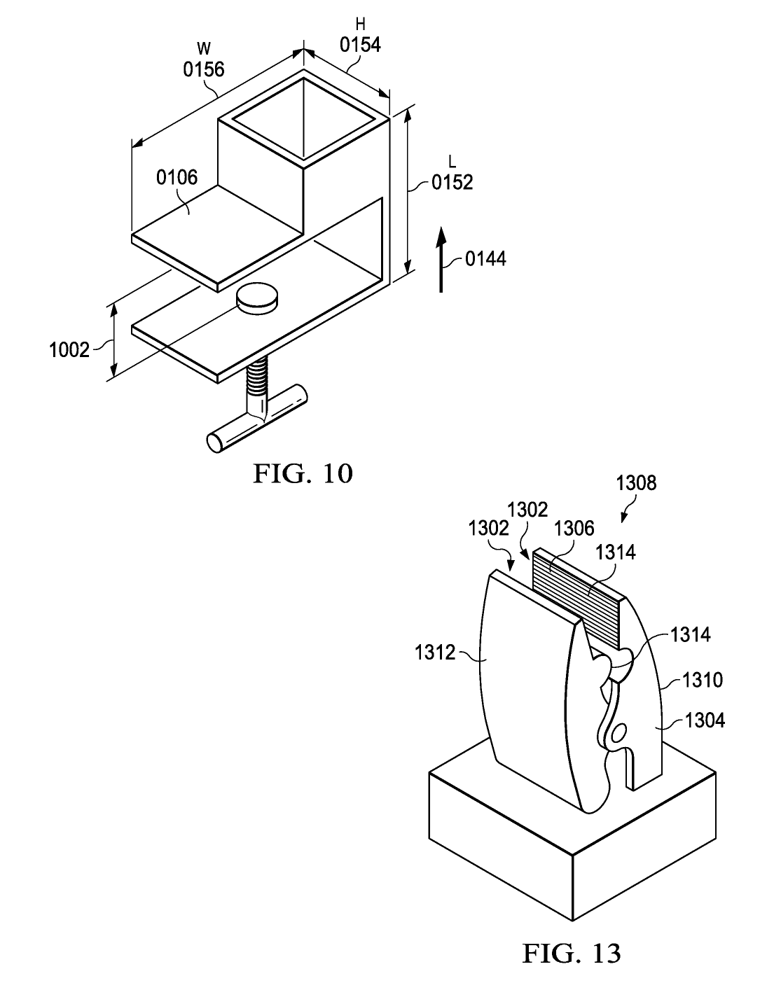

FIG. 8, FIG. 9, and FIG. 10 illustrate multiple approaches to measuring the dimensions of an article described herein. A first approach defines the dimensions of the article with respect to a vertical direction 0144 when the article is in use (e.g., clamped to a structure and holding an object). A vertical reference line 0166 is defined as a vertical line having a first end point 0158 intersecting a horizontal plane that passes through the highest point on the surface of the article and having a second endpoint 0160 intersecting a horizontal plane that passes through the lowest point on the surface of the article, as determined when the article is in use (e.g., in a specific orientation). A horizontal cross-sectional area 0164 of the article can be defined as the area within the perimeter 0168 and/or outer surface of the article in a horizontal plane corresponding to an elevation along the vertical reference line 0166 (e.g., the elevation at point 0162). An average horizontal cross-sectional area of the article can be calculated based on the horizontal cross-sectional area of the article at each elevation along the vertical reference line 0166. Additionally, an imaginary first reference circle can be drawn with a surface area equal to the average horizontal cross-sectional area 0164 of the article. The diameter of the first reference circle provides an equivalent circular diameter for the average horizontal cross-sectional area of the article.

A second approach defines the dimensions of the article with respect to a longest reference line 0170. The longest reference line 0170 is defined as the longest line (or one of a plurality of the longest lines) between any two points 0159, 0161 on the perimeter and/or outer surface of the article. A length-normal cross-sectional area 0165 of the article at a point 0163 along the longest reference line 0170 can be defined as the area within the perimeter 0169 and/or outer surface of the article in a plane intersecting the point 0163 and perpendicular to the longest reference line 0170. An average length-normal cross-sectional area of the article can be calculated based on the length-normal cross-sectional area of the article at each point along the longest reference line 0170. Additionally, a second imaginary reference circle can be drawn with a surface area equal to the average length-normal cross-sectional area of the article. The diameter of the second circle provides an equivalent circular diameter for the average length-normal cross-sectional area of the article.

A third approach is relevant to articles in the form of a rectangular prism, at least partially in the form of a rectangular prism, or articles whose dimensions can be approximated by drawing a rectangular prism that would just contain the object so that each face of the rectangular prism would also intersect at least a point on the surface of the article. For example, a set of three mutually perpendicular dimensions can be defined as length 0152, width-0156 and height 0154. As shown in FIG. 9, the length 0152 for a rectangular prism can be defined as the vertical reference line 0166, described above. Then, the width 0156 can be defined as a dimension measured perpendicular to the length 0152 and parallel to a first face of the rectangular prism. Similarly, the height 0154 can be measured as a second dimension perpendicular to the length 0152 and parallel to a second face of the rectangular prism. As desired, the width 0156 can be larger than the height 0154, the height 0154 can be larger than the width 0156, or the height 0154 can be the same as the width 0156.

A fourth approach is relevant when it is desirable to measure the dimensions of an article with respect to the orientation and dimensions of the elongated body 0108. For example, the vertical reference line 0166, the longest reference line 0170, or the length 0108 of the elongated body 0108 can be measured using any technique described herein. Then, a length 0152 of the article can be defined as the longest distance between two points on the surface of the article along a line parallel to the vertical reference line 0166, parallel to the longest reference line 0170, or parallel to the length 0108 of the elongated body 0108.

An equivalent circular diameter for the average horizontal cross-sectional area of the article can be measured with respect to the length 0152 of the article as it would be measured with respect to the vertical reference line 0166 of the article. Similarly, an equivalent circular diameter for the average length normal cross-sectional area of the article can be measured with respect to the length 0152 of the article as it would be measured with respect to the longest reference line 0170 of the article. Likewise, the width 0156 of the article can be defined as the longest distance between two points on a surface of the article, wherein the longest distance is measured parallel to a width 0156 of the elongated body 0108. Moreover, the height 0154 of the article can be defined as the longest distance between two points on a surface of the article, wherein the longest distance is measured parallel to a height 0154 of the elongated body 0108.

FIG. 10 illustrates a maximum clamp gap 1002, which can vary based on the structural geometry of a clamp 0106. For example, the maximum clamp gap is a maximum distance between opposing surfaces of the clamp that are configured to move together to clamp a support structure. Accordingly, the maximum clamp gap effectively establishes the maximum thickness of a support structure that can be grasped by the clamp.

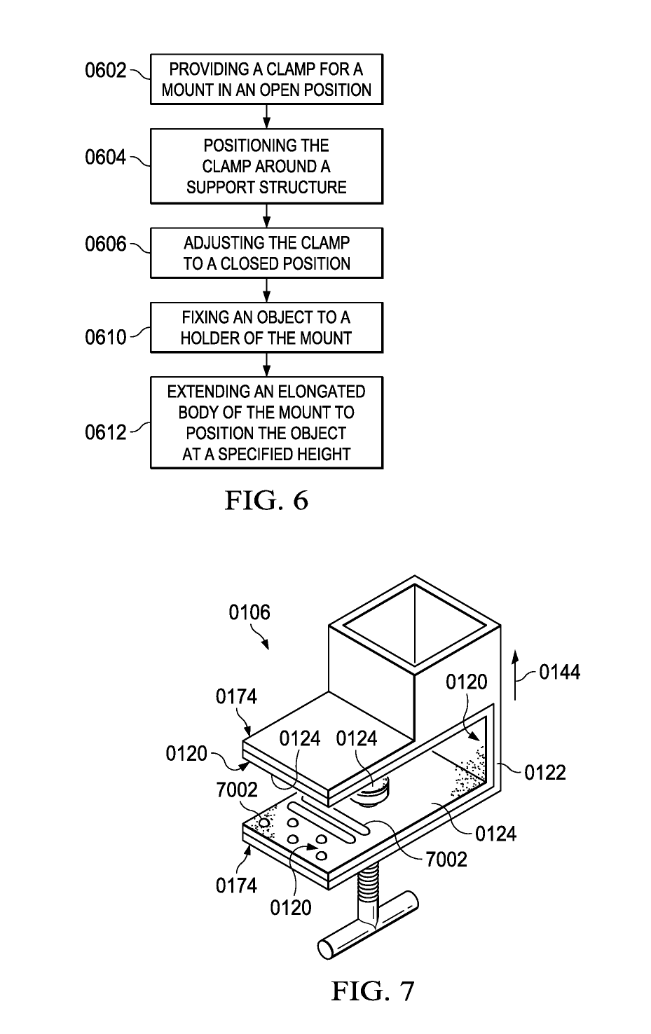

FIG. 6 illustrates a method for using the apparatus to mount an object.

To use the apparatus 0100 for mounting an object, a user needs to adjust clamp 0106 of the mount 0104 of the apparatus 0100 to an open configuration (0602). An example of an open configuration of the clamp is one where the clamp can be moved freely relative to a support structure. The user then positions the clamp 0106 to an edge of a support structure 0136, so that the mount is mounted onto the support structure (0604). The clamp is then adjusted into its closed position, so that mount 0104 is coupled to or grips the support structure 0136 (0606). The last step is coupling the object 0102 to the holder 0114 on top of the apparatus 0100 (0610). Optionally, the method for using the apparatus 0100 can further comprise extending the elongated body 0108 to position the object 0102 at a specified height (e.g., above the standing reach of the user extending the elongated body 0108) (0612), and extending the elongated body can comprise telescoping the elongated body 0108. These steps for using the apparatus 0100 can be performed without a tool.

FIG. 13 illustrates an exemplary embodiment of a holder. As can be seen, in some embodiments, the holder is in the form of a clip. Additionally, the holder can be in the form that is configured to be removably coupled to the mount. The holder 0114 can comprise a holder inner surface 1302. The holder 0114 can comprise a first material 1304 and the holder inner surface 1302 comprises an inner holder material 1306, which can be different from the first material 1304.

In some embodiments, a scratch-avoiding holder inner surface and/or frictional holder inner surface covers: (i) at least a distal portion 1308 of the holder 0114, (ii) at least 30, 40, 50, 60, 70, 80, 90, 95 or 100% of a surface area of a total inner surface area of the holder 0114, (iii) at least a portion of an inner surface area of the holder 0114 that contacts or is configured to contact a support structure 0136 for supporting the mount 0104, (iv) at least a distal portion 1308 of holder inner surface 1302, or a combination thereof.

In some embodiments, the holder is a clip and the clip comprises a plurality of clip jaws (e.g., a first clip jaw 1310 and a second clip jaw 1312) designed to grasp an object.

In some embodiments, the holder comprises at least one protrusion 1314. For example, the at least one protrusion can be configured to grip an object 0102. Furthermore, the at least one protrusion can be a ridge, dimple, peak, tread pattern, plurality thereof, or combination thereof. Additionally, a plurality of protrusions in the at least one protrusion can be mutually spaced, can be mutually parallel, can form an intersecting pattern, can be mutually perpendicular, or a combination thereof. For example, the protrusion can be used to help enable the holder to more securely grasp an object, to help increase a static and/or dynamic coefficient of friction between the object and the holder, to help avoid damaging (e.g. scratching) the object, or any combination thereof.

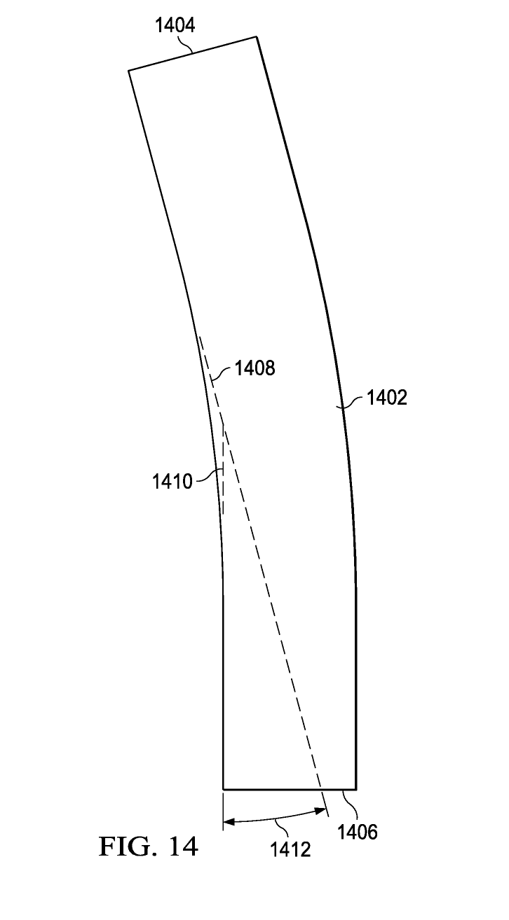

FIG. 14 illustrates how a component of the present invention can be provided with a desired degree of rigidity or flexibility. For example, a component described herein can comprise (e.g., consist of, be made of a material or plurality of materials) that bends by at least and/or no more than 0, 1, 2, 3, 4, 5, 6, 7, 8, 9, 10, 11, 12, 13, 14, or 15 degrees under specified forces, before breaking, under forces expected to be encountered during installation, adjustment, and/or deconstruction, or a combination thereof. For example, a minimum amount of bend can be desirable to absorb shocks without breaking under forces that are likely to be encountered. However, avoiding too much bend can also be desirable to maintain a desired shape, configuration or position of a mount, a component thereof, or an object that a mount is used to position.

As illustrated in FIG. 14, the rigidity or flexibility of a component can be measured as follows. First, as illustrated, the component has a first end 1404 opposite a second end 1406 and separated from the second end by a length of the component comprising a material or plurality of materials. A first line 1408 exists that is parallel to the first end. Similarly, a second line 1410 exists that is parallel to the second end. Accordingly, a bend angle 1412 can be measured as the angle of the second line away from parallel to the first line.

In some embodiments, when the bend angle is measured under a maximum force with a magnitude and direction of application as experienced by a component, material, or plurality of materials during use (e.g., force exerted during assembly, installation, adjustment, disassembly; or any force or weight described herein), the component, material and/or plurality of materials does not bend to provide a bend angle 1412 equal to more than 15, 14, 13, 12, 11, 10, 9, 8, 7, 6, 5, 4, 3, 2, or 1 degrees or a combination thereof.

### Additional Embodiments

The following clauses are offered as further description of the disclosed invention:

1. An apparatus 0100 (e.g., for mounting an object 0102), the apparatus comprising:
a mount 0104, wherein the mount 0104 comprises:

a clamp 0106 (e.g., device used to grasp a structure positioned between two portions of the device, device comprising two portions that can be moved together to apply pressure to a structure positioned between the two portions, c-clamp, vise, etc., or combination thereof);

an elongated body 0108, the elongated body comprising a first portion (e.g., first end portion 0111, for example, first end 0110) and a second portion (e.g., second end portion 0113, for example, second end 0112), wherein the first end portion 0111 is coupled to (e.g., secured or fixed within a specified proximity to, fixed to, removably fixed to, permanently fixed to, attached to, mounted to, clamped to, screwed to, nailed to, bolted to, snapped to, clipped to, adhered to, magnetically attracted to, integral with, of a single piece with, or a combination thereof) the clamp;

a holder 0114 coupled to the second portion (e.g. second end portion 0113) of the elongated body 0108, optionally wherein the holder is for holding the object, capable of holding the object, adapted to hold the object, configured to hold the object, or a combination thereof.

2. The apparatus of any preceding clause, wherein the clamp 0106 is removable.
3. The apparatus of any preceding clause, wherein the holder 0114 is removable.
4. The apparatus of any preceding clause, wherein, the clamp 0106 comprises a horizontal orientation 0116 and/or an opening configured to receive a structure from a direction somewhat perpendicular to, generally perpendicular to, mostly perpendicular to, approximately perpendicular to, or within 45, 30, 25, 20, 15, 10, 5, 4, 3, 2, or 1 degrees of perpendicular to the length 0152, vertical reference line 0166, or longest reference line 0170 of the elongated body 0108 and/or mount 0104.
5. The apparatus of any preceding clause, wherein, the clamp 0106 comprises a vertical orientation 0118 and/or an opening configured to receive a structure from a direction somewhat parallel to, generally parallel to, mostly parallel to, approximately parallel to, or within 45, 30, 25, 20, 15, 10, 5, 4, 3, 2, or 1 degrees of parallel to the length 0152, vertical reference line 0166, or longest reference line 0170 of the elongated body 0108 and/or mount 0104.
6. The apparatus of any preceding clause, wherein, the clamp 0106 comprises a clamp inner surface 0120;

optionally, wherein the clamp 0106 comprises a first material 0122 and the clamp inner surface 0120 comprises an inner clamp material 0124;

optionally, wherein the clamp inner surface 0120 is damage-avoidant (e.g., avoiding harm to a fabric, for example, by creating runners, loose threads, or tears in the fabric) and/or scratch-avoidant (e.g., soft inner surface, inner surface having a scratch hardness less than the scratch hardness of a support structure 0136 in contact with or gripped by the inner surface, rubber inner surface, rubberized inner surface, silicone rubber inner surface, or a combination thereof);

optionally, wherein the clamp inner surface 0120 is frictional (e.g., having a friction-enhancing coating to increase the coefficient of static friction between the inner surface and a support structure 0136 in contact with or gripped by the inner surface; having a coefficient of static friction in conjunction with a support structure in contact with or gripped by the inner surface, wherein the coefficient of static friction is at least 0.1, 0.2, 0.3, 0.4, 0.5, 0.6, 0.7, 0.8, 0.9, 1, or 1.1; having a coefficient of static friction in conjunction with a support structure 0136 in contact with or gripped by the inner surface, wherein the coefficient of static friction is no more than 0.2, 0.3, 0.4, 0.5, 0.6, 0.7, 0.8, 0.9, 1.0, 1.1, or 1.2; or a combination thereof);

optionally, wherein a scratch-avoiding clamp inner surface and/or frictional clamp inner surface covers: (i) at least a distal portion 0174 of the clamp 0106, (ii) at least 30, 40, 50, 60, 70, 80, 90, 95 or 100% of a surface area of a total inner surface area of the clamp 0106, (iii) at least a portion of an inner surface area of the clamp 0106 that contacts or is configured to contact a support structure 0136 for supporting the mount 0104.

7. The apparatus of any preceding clause, wherein, the clamp 0106 comprises a clamp spindle assembly 0126; optionally the spindle assembly 0126 comprises a support-structure contacting portion 0176, a rotation-facilitation portion 0178 spaced from the support-structure contacting portion, and a threaded portion 0180 designed to engage a corresponding threaded portion 0182 of the clamp; optionally wherein the support-structure contacting portion 0176 has a flat surface configured to be in contact with a support structure 0136 that the clamp is configured to grasp; optionally wherein the rotation-facilitation portion 0178 is configured to be rotated by hand (e.g., grasped directly by a person's hand) and to facilitate the application of a torque to the threaded portion 0180; optionally, wherein the rotation-facilitation portion 0178 comprises a bar oriented somewhat perpendicular to, generally perpendicular to, mostly perpendicular to, or within 45, 30, 25, 20, 15, 10, 5, 4, 3, 2, or 1 degrees of perpendicular to a longitudinal dimension 0184 of the threaded portion 0180 of the spindle assembly 0126.
8. The apparatus of any preceding clause, wherein, the elongated body 0108 comprises a push button insert 0128 and a plurality of apertures 0130 (e.g., holes) for the push button insert 0128, optionally wherein the plurality of apertures are for receiving the push button insert, capable of receiving the push button insert, adapted to receive the push button insert, configured to receive the push button insert, or a combination thereof.
9. The apparatus of any preceding clause, wherein, the elongated body 0108 comprises a spring lock (e.g., a spring-loaded mechanism; a spring-loaded push button insert 0128 that extends through an aperture 0130; spring-loaded latch comprising a portion configured to engage a protrusion, indention or aperture; spring-loaded mechanism configured to prevent extension or retraction of a telescoping portion of the elongated body while the spring-loaded mechanism is engaged; or a combination thereof), for adjusting the elongated body 0108 to and/or maintaining the elongated body at different sizes in a selected dimension (e.g., length 0152, vertical reference line 0166, or longest reference line 0170), optionally, wherein the different sizes comprise a minimum size of no more than 2, 3, 4, or 5 feet and a maximum size of at least 5, 6, 7, or 8 feet.
10. The apparatus of any preceding clause, wherein, the holder 0114 (and/or a plurality of arms 0306 of the holder, or each arm 0306 of the holder) comprises a component selected from the group consisting of: a clip; an aperture (e.g., a slot, a hole); a plurality of arms 0306 (e.g., 2, 3, or 4), a magnetic, or a combination thereof.
11. The apparatus of any preceding clause, wherein the holder 0114 comprises a holder inner surface 1302;

optionally, wherein the holder 0114 comprises a first material 1304 and the holder inner surface 1302 comprises an inner holder material 1306;

optionally, wherein the holder inner surface 1302 is damage-avoidant (e.g., avoiding harm to a fabric, for example, by creating runners, loose threads, or tears in the fabric) and/or scratch-avoidant (e.g., soft inner surface, inner surface having a scratch hardness less than the scratch hardness of a support structure 0136 in contact with or gripped by the inner surface, rubber inner surface, rubberized inner surface, silicone rubber inner surface, or a combination thereof);

optionally, wherein the holder inner surface 1302 is frictional (e.g., having a friction-enhancing coating to increase the coefficient of static friction between the inner surface and an object 0102 in contact with or gripped by the inner surface; having a coefficient of static friction in conjunction with an object 0102 in contact with or gripped by the inner surface, wherein the coefficient of static friction is at least 0.1, 0.2, 0.3, 0.4, 0.5, 0.6, 0.7, 0.8, 0.9, 1, or 1.1; having a coefficient of static friction in conjunction with an object 0102 in contact with or gripped by the inner surface, wherein the coefficient of static friction is no more than 0.2, 0.3, 0.4, 0.5, 0.6, 0.7, 0.8, 0.9, 1.0, 1.1, or 1.2; or a combination thereof);

optionally, wherein a damage-avoiding holder inner surface, scratch-avoiding holder inner surface and/or frictional holder inner surface covers: (i) at least a distal portion of the holder 0114, (ii) at least 30, 40, 50, 60, 70, 80, 90, 95 or 100% of a surface area of a total inner surface area of the holder 0114, (iii) at least a portion of an inner surface area of the holder 0114 that contacts or is configured to contact a support structure 0136 for supporting the mount 0104, (iv) at least a distal portion 1308 of holder inner surface 1302, or a combination thereof.

12. The apparatus of any preceding clause, wherein, the apparatus further comprises a support structure for supporting the mount 0104, optionally, wherein the support structure 0136 comprises a protrusion that fits inside the clamp 0106, and optionally, wherein the support structure 0136 comprises a table (e.g. table ledge), a chair (e.g., arm or back of a chair), or rail (e.g., bed rail).
13. The apparatus of any preceding clause, wherein, the elongated body 0108 comprises a rectangular prism-shaped (e.g., square, rectangular) cross-section.
14. The apparatus of any preceding clause, wherein, the elongated body 0108 comprises a round (e.g., oval-shaped, circle-shaped) cross-section.
15. The apparatus of any preceding clause, wherein the elongated body 0108 comprises a telescoping portion; optionally, wherein the elongated body 0108 comprises a telescopic ratio defined as a maximum size for a selected dimension (e.g., length 0152, vertical reference line 0166, or longest reference line 0170) of elongated body 0108 divided by a minimum size for the selected dimension of the elongated body 0108, wherein the telescopic ratio is at least or greater than 1.1, 1.2, 1.3, 1.4, 1.5, 1.6, 1.7, 1.8, 1.9, 2.0, 2.5, 3.0, 3.5, 4.0, 5.0, 6.0, 7.0, 8.0, 9.0, 10.0, wherein the telescopic ratio is no more than or less than 1.5, 1.6, 1.7, 1.8, 1.9, 2.0, 2.5, 3.0, 3.5, 4.0, 5.0, 6.0, 7.0, 8.0, 9.0, 10.0, or a combination thereof.
16. The apparatus of any preceding clause, wherein the holder 0114 comprises a first arm 0306 and a second arm 0306, wherein the first arm and the second arm are approximately perpendicular (e.g., within 30, 25, 20, 15, 10, 9, 8, 7, 6, 5, 4, 3, 2, or 1 degrees from perpendicular) to a longitudinal dimension (e.g., parallel to vertical direction 0144 in FIG. 5) of the elongated body 0108 and the first arm is located opposite the second arm.
17. The apparatus of any preceding clause, wherein the holder 0114 comprises a holder connector (e.g., collar 0140, cap, lip, clamp, etc., or a combination thereof), for example, at one portion (e.g., end portion, for example, end), configured to couple the holder 0114 to the elongated body 0108 (e.g., a corresponding holder connector of the elongated body) and, optionally wherein a portion (e.g., an end portion) of the elongated body 0108 adjacent to the holder 0114 (e.g., a corresponding holder connector of the elongated body) is configured to engage (e.g., mate with) the holder connector to couple the holder 0114 to the elongated body 0108, optionally wherein the holder connector comprises a collar 0140 and has a size in a selected dimension (e.g., length 0152, vertical reference line 0166, or longest reference line 0170) of at least and/or no more than 0.25, 0.5, 0.75, 1, 2, 3, 4, 5, 6, 7, 8, 9, 10, 11, 12 inches and a thickness of at least and/or no more than 0.1, 0.2, 0.3, 0.4, 0.5, 0.6, 0.7, 0.8, 0.9, or 1 inches, optionally wherein the holder connector comprises a tensioning screw 2002 to couple the holder 0114 to the elongated body 0108, optionally wherein the tensioning screw 2002 comprises a lever arm 2006 (e.g., at a distal portion of the screw) to assist a user in turning the tensioning screw.
18. The apparatus of any preceding clause, wherein the clamp 0106 comprises a clamp connector (e.g., collar 0138, cap, lip, clamp, etc., or a combination thereof), for example, at one end portion (e.g., end), configured to couple the clamp 0106 to the elongated body 0108 (e.g., a corresponding clamp connector of the elongated body) and, optionally wherein an end portion of the elongated body 0108 (e.g., a corresponding holder connector of the elongated body) adjacent to the clamp 0106 is configured to engage (e.g., mate with) the clamp connector to couple the clamp 0106 to the elongated body 0108, optionally wherein the clamp connector comprises a collar 0138 and has a size in a selected dimension (e.g., length 0152, vertical reference line 0166, or longest reference line 0170) of at least and/or no more than 0.25, 0.5, 0.75, 1, 2, 3, 4, 5, 6, 7, 8, 9, 10, 11, 12 inches and a thickness of at least and/or no more than 0.1, 0.2, 0.3, 0.4, 0.5, 0.6, 0.7, 0.8, 0.9, or 1 inches, optionally wherein the clamp connector comprises a tensioning screw 2004 to couple the clamp 0106 to the elongated body 0108, optionally wherein the tensioning screw 2002 comprises a lever arm 2008 (e.g., at a distal portion of the screw) to assist a user in turning the tensioning screw.
19. The apparatus of any preceding clause or any clause herein, optionally wherein at least one component comprises, at least one component is at least 50, 60, 70, 80, 90, 95, 96, 97, 98, or 99%, or at least one component consists of a material selected from the group consisting of: metal (e.g., aluminum, iron, titanium, steel, carbon steel, stainless steel, alloy), polymer (e.g., plastic, resin, rubber, silicone rubber) ceramic, carbon fiber, wood (e.g., hard wood, softwood, etc., or a combination thereof), plant fiber, a material 1402 that is rigid (e.g., given a first end 1404 opposite a second end 1406 and separated from the second end by a length of the material 1402 or component comprising the material, given a first line 1408 parallel to the first end 1404, given a second line 1410 parallel to the second end 1406, and given a bend angle 1412 measured as the angle of the second line 1410 away from parallel to the first line 1408, the material does not have a bend angle 1412 equal to more than 15, 14, 13, 12, 11, 10, 9, 8, 7, 6, 5, 4, 3, 2, or 1 degrees or a combination thereof under the forces experienced by the material or component during use (e.g., assembly, installation, adjustment, disassembly), for example, any force described herein or weight described herein;

optionally wherein the at least one component (e.g., any component listed herein, all of the components making up the clamp 0106, elongated body 0108, holder 0114, or a combination thereof; or all of the components making up the mount 0104) weigh no more than 75, 60, 50, 40, 30, 20, 15, 10, 5, 4, 3, 2, 1, 0.5, 0.4, 0.3, 0.2, or 0.1 lbs;

optionally wherein the at least one component is selected from the group: clamp 0106, inner clamp material 0124, elongated body 0108, holder 0114 (e.g., clip, arm, arms, inner holder material 1306, combination thereof), holder connector, clamp connector, toggle, tensioning screw, lever arm, support structure 0136 (e.g., arm, table, chair, rail), any other component recited in this disclosure, a portion thereof, or a combination thereof.

20. The apparatus of any preceding clause wherein the clamp 0106 comprises at least one dimension selected from the group consisting of:

an outer diameter equal to at least and/or no more than 1, 1.5, 2, 2.5, 3, 3.5, or 4 inches;

an inner diameter equal to at least and/or no more than 1, 1.5, 2, 2.5, 3, 3.5, or 4 inches;

a thickness equal to at least and/or no more than 1/64, 1/32, 1/24, 1/12, ⅙, ¼, ⅓, ½, ⅔, ¾, or 1 inches;

a length 0152 (e.g., longest dimension, longest distance between two points on a perimeter and/or outer surface of the clamp 0106, and/or as defined herein), fully extended/retracted length, fully extended/retracted distance from an uppermost portion of the clamp in contact with (or configured to be in contact with) the support structure to a bottommost portion of a holder in contact with (or configured to be in contact with) an object held by the holder, vertical reference line 0166, or longest reference line 0170 equal to at least and/or no more than 12, 11, 10, 9, 8, 7, 6, 5, 4, 3, 2, or 1 inches;

a width 0156 (e.g., dimension measured perpendicular to longest dimension, longest distance between two points on perimeter and/or outer surface of the clamp 0106 as measured perpendicular to longest dimension, and/or as defined herein), equivalent circular diameter for the average horizontal cross-sectional area of the clamp, or equivalent circular diameter for the average length-normal cross-sectional area of the clamp equal to at least and/or no more than no more than 12, 11, 10, 9, 8, 7, 6, 5, 4, 3, 2, or 1 inches;

a maximum clamp gap 1002 for clamping equal to at least and/or no more than 1/64, 1/32, 1/24, 1/12, ⅙, ¼, ⅓, ½, ⅔, ¾, 1, 2, 3, 4, or 5 inches;

a weight equal to at least and/or no more than 15, 10, 9, 8, 7, 6, 5, 4, 3, 2, 1, 15/16, 14/16, 13/16, 12/16, 11/16, 10/16, 9/16, 8/16, 7/16, 6/16, 5/16, 4/16, 3/16, 2/16, or 1/16 lbs; or

a combination thereof.

21. The apparatus of any preceding clause wherein the elongated body 0108 comprises at least one dimension selected from the group consisting of:

an outer diameter equal to at least and/or no more than 1, 1.5, 2, 2.5, 3, 3.5, or 4 inches;

an inner diameter equal to at least and/or no more than 1, 1.5, 2, 2.5, 3, 3.5, or 4 inches;

a thickness equal to at least and/or no more than 1/64, 1/32, 1/24, 1/12, ⅙, ¼, ⅓, 12, ⅔, ¾, or 1 inches;

a length 0152 (e.g., longest dimension, longest distance between two points on perimeter and/or outer surface of the elongated body 0108, and/or as defined herein), vertical reference line 0166, or longest reference line 0170 equal to at least and/or no more than 9, 8, 7, 6, 5, 4, 3, 2, or 1 ft.;

a minimum telescoping size for a selected dimension (e.g., length 0152 (e.g., longest dimension, longest distance between two points on perimeter and/or outer surface of the elongated body 0108, and/or as defined herein), vertical reference line 0166, or longest reference line 0170) equal to at least and/or no more than 9, 8, 7, 6, 5, 4, 3, 2, or 1 ft.;

a maximum telescoping size for a dimension (e.g., length 0152 (e.g., longest dimension, longest distance between two points on perimeter and/or outer surface of the elongated body 0108, and/or as defined herein), vertical reference line 0166, or longest reference line 0170) equal to at least and/or no more than 9, 8, 7, 6, 5, 4, 3, 2, or 1 ft.;

a width (e.g., dimension measured perpendicular to longest dimension, longest distance between two points on perimeter and/or outer surface of the elongated body 0108 as measured perpendicular to longest dimension, and/or as defined herein), equivalent circular diameter for the average horizontal cross-sectional area of the elongated body, or equivalent circular diameter for the average length-normal cross-sectional area of the elongated body equal to at least and/or no more than 12, 11, 10, 9, 8, 7, 6, 5, 4, 3, 2, or 1 inches;

a weight equal to at least and/or no more than 50, 40, 30, 20, 15, 10, 9, 8, 7, 6, 5, 4, 3, 2, or 1 lbs.; or

a combination thereof.

22. The apparatus of any preceding clause wherein the holder 0114 (e.g., a component of the holder, an arm, plurality of arms, a clip, a first clip jaw 1310, a second clip jaw 1312, or a combination thereof) comprises at least one dimension selected from the group consisting of:

a thickness equal to at least and/or no more than 1/64, 1/32, 1/24, 1/12, ⅙, ¼, ⅓, ½, ⅔, ¾, or 1 inches;

a length 0152 (e.g., longest dimension, longest distance between two points on perimeter and/or outer surface of the holder 0114, and/or as defined herein), vertical reference line 0166, or longest reference line 0170 equal to at least and/or no more than 12, 11, 10, 9, 8, 7, 6, 5, 4, 3, 2, or 1 inches;

a width (e.g., dimension measured perpendicular to longest dimension, longest distance between two points on perimeter and/or outer surface of the holder 0114 as measured perpendicular to longest dimension, and/or as defined herein), equivalent circular diameter for the average horizontal cross-sectional area of the holder, or equivalent circular diameter for the average length-normal cross-sectional area of the holder equal to at least and/or no more than 12, 11, 10, 9, 8, 7, 6, 5, 4, 3, 2, or 1 inches;

a maximum holder gap for holding an object across a thickness of the object equal to at least and/or no more than 1/64, 1/32, 1/24, 1/12, ⅙, ¼, ⅓, ½, ⅔, ¾, 1, 2, 3, 4, or 5 inches;

a weight equal to at least and/or no more than 15, 10, 9, 8, 7, 6, 5, 4, 3, 2, 1, 15/16, 14/16, 13/16, 12/16, 11/16, 10/16, 9/16, 8/16, 7/16, 6/16, 5/16, 4/16, 3/16, 2/16, or 1/16 lbs.; or

a combination thereof.

23. The apparatus of any preceding clause wherein a support structure 0136 (e.g., table, chair, rail, portion thereof, portion thereof to which the clamp 0106 is coupled, a combination thereof) comprises at least one dimension selected from the group consisting of:

a thickness equal to at least and/or no more than 1/64, 1/32, 1/24, 1/12, ⅙, ¼, ⅓, ½, ⅔, ¾, 1, 2, 3, 4, or 5 inches;

a length (e.g., longest dimension, longest distance between two points on perimeter and/or outer surface of the holder 0114, and/or as defined herein), vertical reference line 0166, or longest reference line 0170 equal to at least and/or no more than 300, 200, 100, 50, 25, 10, 9, 8, 7, 6, 5, 4, 3, 2, ft., or 12, 11, 10, 9, 8, 7, 6, 5, 4, 3, 2, or 1 inches;

a width (e.g., dimension measured perpendicular to longest dimension, longest distance between two points on perimeter and/or outer surface of the clamp 0106 as measured perpendicular to longest dimension, and/or as defined herein), equivalent circular diameter for the average horizontal cross-sectional area of the support structure, or equivalent circular diameter for the average length-normal cross-sectional area of the support structure equal to at least and/or no more than no more than 25, 10, 9, 8, 7, 6, 5, 4, 3, 2, ft., or 12, 11, 10, 9, 8, 7, 6, 5, 4, 3, 2, or 1 inches;

a weight equal to at least and/or no more than 500, 400, 300, 200, 100, 50, 40, 30, 20, 10, 9, 8, 7, 6, 5, 4, 3, 2, 1, 15/16, 14/16, 13/16, 12/16, 11/16, 10/16, 9/16, 8/16, 7/16, 6/16, 5/16, 4/16, 3/16, 2/16, or 1/16 lbs.; or

a combination thereof.

24. The apparatus of any preceding clause wherein an object 0102 (e.g., light, string of lights, banner, fabric, material, flexible material, decoration, portion thereof, portion thereof to which the holder 0114 is coupled, or a combination thereof) comprises a bottom and the bottom is positioned at least 6, 7, 8, 9 or 10 feet above a support surface 0186 (e.g., ground, floor, etc., or a combination thereof) which supports the support structure 0136 (e.g., upon which the support structure 0136 is positioned or is resting); and/or

wherein the object 0102 comprises at least one dimension selected from the group consisting of:

a thickness equal to at least and/or no more than 1/64, 1/32, 1/24, 1/12, ⅙, ¼, ⅓, ½, ⅔, ¾, 1, 2, 3, 4, or 5 inches;

a length (e.g., longest dimension, longest distance between two points on perimeter and/or outer surface of the holder 0114, and/or as defined herein), vertical reference line 0166, or longest reference line 0170 equal to at least and/or no more than 10, 9, 8, 7, 6, 5, 4, 3, 2, or 1 ft., or 12, 11, 10, 9, 8, 7, 6, 5, 4, 3, 2, or 1 inches;

a width (e.g., dimension measured perpendicular to longest dimension, longest distance between two points on perimeter and/or outer surface of the holder 0114 as measured perpendicular to longest dimension, and/or as defined herein), equivalent circular diameter for the average horizontal cross-sectional area of the object 0102, or equivalent circular diameter for the average length-normal cross-sectional area of the object 0102 equal to at least and/or no more than 10, 9, 8, 7, 6, 5, 4, 3, 2, or 1 ft., 12, 11, 10, 9, 8, 7, 6, 5, 4, 3, 2, or 1 inches;

a weight equal to at least and/or no more than 15, 10, 9, 8, 7, 6, 5, 4, 3, 2, 1, 15/16, 14/16, 13/16, 12/16, 11/16, 10/16, 9/16, 8/16, 7/16, 6/16, 5/16, 4/16, 3/16, 2/16, or 1/16 lbs.; or

a combination thereof.

25. The apparatus of any preceding clause wherein the clamp 0106 (e.g., any material or component that makes up the clamp 0106, clamp inner surface 0120, inner clamp material 0124, or a combination thereof) comprises at least one protrusion 7002 (e.g., ridge, dimples, peaks, tread pattern, plurality thereof, combination thereof, optionally mutually spaced, optionally mutually parallel, optionally mutually perpendicular, optionally configured to grip a support structure 0136 (e.g., any support structure described herein) or a combination thereof).
26. The apparatus of any preceding clause wherein the holder 0114 (e.g., any material or component that makes up the holder 0114, holder inner surface, inner holder material 1306, or a combination thereof) comprises at least one protrusion 1314 (e.g., ridge, dimples, peaks, tread pattern, plurality thereof, combination thereof, optionally mutually spaced, optionally mutually parallel, optionally intersecting pattern, optionally mutually perpendicular, optionally configured to grip an object 0102 (e.g., any object described herein)).
27. The apparatus of any preceding clause wherein a force required to actuate a component described herein or any combination thereof is no more than 50, 40, 30, 20, 15, 10, 9, 8, 7, 6, 5, 4, 3, 2 or 1 lbs.-force, optionally wherein to actuate is a function selected from the group consisting of to loosen, to tighten, to twist, to screw, to turn, to push, to pull, to elongate, to extend, to retract, to perform any function described herein, any combination thereof).
28. A mount 0104 (e.g., for positioning an object 0102 a specified distance from a support structure 0136), the mount comprising:

a clamp 0106 (e.g., adjustable clamp), optionally configured to grip the support structure 0136;

an elongated body 0108 comprising a first portion (e.g., first end portion 0111, for example, first end 0110) and a second portion (e.g., second end portion 0113, for example, second end 0112), wherein the first portion (e.g., first end portion 0111) of the elongated body 0108 is coupled to the clamp 0106; and

a holder 0114 coupled to the second portion (e.g., second end portion 0113) of the elongated body 0108.

29. A method of using the apparatus of any preceding clause or the mount 0104 of clause 28 for mounting an object 0102, the method comprising:

providing the clamp 0106 in an open configuration (e.g., adjusting the clamp to an open configuration);

positioning the clamp 0106 around a support structure 0136 (e.g., an edge of the support structure);

adjusting the clamp 0106 to a closed position (e.g., so that the mount 0104 is coupled to (e.g., secured or fixed within a specified proximity to, fixed to, removably coupled to, permanently fixed to, attached to, mounts to, screwed to, nailed to, bolted to, snapped to, clipped to, adhered to, magnetically attracted to, integral with, of a single piece with, clamps, grips, or a combination thereof) the support structure 0136), optionally, sufficiently securely and/or stably so that clamp 0106 does not slide relative to the support structure 0136 upon application of a force equal to a weight of at least 1, 2, 3, 4, 5, 10, 20, 30, 40, 50, 100, 150, 200, 250, or 300 lbs.-force); and

coupling (e.g., securing or fixing within a specified proximity to, fixing to, removably coupling to, permanently fixing to, attaching to, mounting to, screwing to, nailing to, bolting to, snapping to, clipping to, adhering to, magnetically attracting to, being integral with, being of a single piece with, clamping, gripping, or a combination thereof) the object to the holder 0114 (e.g., located on top of the apparatus).

30. The method of any preceding clause, further comprising adjusting a size (e.g., telescoping, extending or retracting a length 0152, vertical reference line 0166, longest reference line 0170, or other dimension described herein) of the elongated body 0108 of the mount:

(i) to position the object at a specified height (e.g., above the standing reach of a person adjusting the size of the elongated body 0108, wherein the person is standing on a support surface 0186 (e.g., ground, floor, etc., or a combination thereof), wherein the support surface supports the support structure 0136, and/or wherein the support structure 0136 is positioned or is resting on the support surface);

(ii) to position a bottom of the object at least 6, 7, 8, 9, or 10 feet above a support surface 0186 that supports the support structure 0136; or

(iii) a combination thereof.

31. The method of clause 30, wherein adjusting the elongated body 0108 comprises telescoping the elongated body 0108.
32. The method of any preceding clause, wherein steps of the method are performed without a tool (e.g., ladder, screw driver, drill, wrench, etc., or a combination thereof) and/or without using any component that is not a component of the mount.
33. The method, apparatus or mount of any preceding clause, wherein the apparatus, mount, a component of the apparatus, a component of the mount, a clamp, a holder, an elongated body, or any combination thereof is made of a material compatible with using 3D printing or automatic laser cutting to make the apparatus, mount, a component of the apparatus, a component of the mount, a clamp, a holder, an elongated body, or any combination thereof.
34. The method, apparatus or mount of any preceding clause, wherein the apparatus, mount, a component of the apparatus, a component of the mount, a clamp, a holder, an elongated body, or any combination thereof is made using 3D printing or automatic laser cutting.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. For example, it should be understood that the method steps described herein are exemplary, and upon reading the present disclosure, a skilled person would understand that one or more method steps described herein can be combined, omitted, re-ordered, or substituted.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

Additionally, where an embodiment is described herein with reference to a clamp, a new embodiment can be created by replacing the clamp with a support-structure coupling that couples the apparatus, mount, or elongated body to a support structure. Examples of support-structure couplings include a clamp, magnet, adhesive, screw, bolt, nut, threaded connection, plurality thereof, and/or combination thereof.

Additionally, where an embodiment is described with a first end portion, an additional embodiment can be created by replacing the first end portion with a first portion. Additionally and/or alternatively, where an embodiment is described with a second end portion, an additional embodiment can be created by replacing the second end portion with a second portion.

Additionally, when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, if the application were to disclose an embodiment in which a variable is 1 and a second embodiment in which the variable is 3-5, a third embodiment can be created in which the variable is 1.31-4.23. Similarly, a fourth embodiment can be created in which the variable is 1-5.

As used herein, examples of “substantially” include: “more so than not,” “mostly,” and “at least 30, 40, 50, 60, 70, 80, 90, 95, 96, 97, 98 or 99%” with respect to a referenced characteristic. With respect to vectors, directions, movements or angles, that are “substantially” in the same direction as or parallel to a reference vector, direction, movement, angle or plane, “substantially” can also mean “at least a component of the vector, direction, movement or angle specified is parallel to the reference vector, direction, movement, angle or plane,” although substantially can also mean within plus or minus 45, 40, 35, 30, 25, 20, 15, 10, 5, 4, 3, 2, or 1 degrees of the reference vector, direction, movement, angle or plane.

Additionally, when an embodiment is described herein using the phrase “and/or” in conjunction with a list of items or features, as a skilled person would understand, embodiments can be provided including one item or feature from the list, any selection of items or features from the list, or all the items or features from the list. For example, given an embodiment “in which the clamp inner surface can be provided, configured, positioned and/or oriented to prevent damage to a support structure,” a skilled person would understand that “the clamp inner surface can be provided to prevent damage to the support structure, configured to prevent damage to the support structure, positioned to prevent damage to the support structure, oriented to prevent damage to the support structure, or a combination thereof.”

As another example, if an embodiment is described herein reciting the phrase “longest reference line equal to at least and/or no more than 12, 11, 10, 9, 8, 7, 6, 5, 4, 3, 2, or 1 inches”, then an embodiment can be provided wherein the “longest reference line” is “equal to at least 12, 11, 10, 9, 8, 7, 6, 5, 4, 3, 2, or 1 inches, no more than 12, 11, 10, 9, 8, 7, 6, 5, 4, 3, 2, or 1 inches, or a combination thereof.” As an illustration, the “longest reference line” can be “equal to 1 to 12 inches.”

Moreover, when an embodiment is described herein using one of the terms or phrases “to”, “for”, “capable of”, “adapted to”, “configured to”, or “designed to” coupled with a recited feature, purpose, function, advantage, characteristic, property or object, one of the listed terms or phrases can be substituted for the used term or phrase to provide an embodiment of the present disclosure. For example, if the present disclosure recites “mounts for positioning an object”, an embodiment can provide “mounts capable of positioning the object”, “mounts adapted to position the object”, “mounts configured to position the object”, “mounts designed to position the object”, or a combination thereof. Similarly, if the present disclosure recites “a holder for an object”, and embodiment can provide “a holder capable of holding the object”, “a holder adapted to hold the object”, “a holder configured to hold the object”, “a holder designed to hold the object”, or a combination thereof.

While this invention has been particularly shown and described with reference to preferred embodiments, it will be understood by those skilled in the art that various changes in form and detail can be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method of using a mount comprising a clamp coupled to an elongated body, wherein the elongated body is coupled to a holder for an object, the method comprising:
providing the clamp in an open configuration;
positioning the clamp around a support structure;
adjusting the clamp to a closed position to removably fix the clamp to the support structure; and
coupling the object to the holder.

2. The method of claim 1, further comprising adjusting a size of the elongated body of the mount to position the object at a specified height.

3. The method of claim 2, wherein the specified height is above the standing reach of a person adjusting the size of the elongated body while the person is standing on a support surface, wherein the support surface also supports the support structure.

4. The method of claim 2, wherein the adjusting the size of the elongated body of the mount is effective to position a bottom of the object at least 7 feet above a support surface that supports the support structure.

5. The method of claim 2, wherein adjusting the elongated body comprises telescoping the elongated body to extend the elongated body.

6. The method of claim 1, wherein the claimed steps of the method are performed without a tool.

7. The method of claim 1, wherein the claimed steps of the method are performed without a tool.

8. The method of claim 1, wherein the claimed steps of the method are performed without using any component that is not a component of the mount.

9. An apparatus, the apparatus comprising:
a mount, wherein the mount comprises:
a clamp;
an elongated body, the elongated body comprising a first end portion and a second end portion, wherein the first end portion is coupled to the clamp;
a holder coupled to the second end portion of the elongated body.

10. The apparatus of claim 9, wherein the clamp is removable.

11. The apparatus of claim 9, wherein the holder is removable.

12. The apparatus of claim 9, wherein, the clamp comprises a clamp inner surface, wherein the clamp inner surface is scratch-avoidant.

13. The apparatus of claim 9, wherein, the clamp comprises a clamp inner surface that contacts a support structure, and wherein, in conjunction with the support structure, the clamp inner surface has a static coefficient of friction of at least 0.5.

14. The apparatus of claim 9, wherein the holder comprises an aperture.

15. The apparatus of claim 9, wherein the holder comprises at least two arms and each arm comprises a clip.

16. The apparatus of claim 9, wherein the apparatus weighs no more than 20 lbs.

17. The apparatus of claim 9, wherein the clamp is configured to be coupled to a support structure, wherein the holder is configured to be coupled to an object, wherein the mount provides a fully extended length of at least 6 feet, wherein the fully extended length is measured from an uppermost portion of the clamp configured to be in contact with the support structure to a bottommost portion of the holder configured to be in contact with the object.

18. The apparatus of claim 9, wherein a force required to be applied by a user to couple the clamp to a support structure, to couple the holder to an object, and to extend and retract a length of the elongated body does not exceed 20 lbs.-force, exclusive of the weight of any object coupled to the holder.

19. The apparatus of claim 9, wherein the holder comprises a holder connector at an end portion of the holder, wherein the holder connector is configured to couple the holder to an end portion of the elongated body, wherein the end portion of the elongated body is adjacent to the end portion of the holder.

20. The apparatus of claim 9, wherein the clamp comprises a clamp connector at an end portion of the clamp, wherein the clamp connector is configured to couple the clamp to an end portion of the elongated body, wherein the end portion of the elongated body is adjacent to the end portion of the clamp.
